(19) United States
(12) Patent Application Publication
(10) Pub. No.: US 2022/0249916 A1
(43) Pub. Date: Aug. 11, 2022

(54) GOLF BALL AND METHOD OF MANUFACTURE

(71) Applicant: Bridgestone Sports Co., Ltd., Tokyo (JP)

(72) Inventor: Jun SHINDO, Chichibushi (JP)

(73) Assignee: Bridgestone Sports Co., Ltd, Tokyo (JP)

(21) Appl. No.: 17/724,578

(22) Filed: Apr. 20, 2022

Related U.S. Application Data
(63) Continuation-in-part of application No. 17/120,449, filed on Dec. 14, 2020, now Pat. No. 11,338,178.

(30) Foreign Application Priority Data
Dec. 24, 2019 (JP) 2019-233130

(51) Int. Cl. A63B 37/00; B29D 99/00; C08F 279/02; C08K 3/22

(52) U.S. Cl. CPC A63B 37/0051; A63B 37/0063; A63B 37/0065; B29D 99/0042; B29K 2067/06; C08K 3/22; B29K 2995/007; B29K 2995/0088; C08F 279/02

(57) ABSTRACT

In a golf ball having a core composed of one or more layer, the outermost layer of the core is formed of a rubber composition containing a base rubber and an α,β-unsaturated metal carboxylate, an envelope layer directly encasing the core is formed of a resin composition containing a thermoplastic resin having a structure that includes α,β-ethylenically unsaturated carboxylic acid copolymerization units which accounts for at least 50 wt % of the resin composition, and a surface of the core outermost layer and the envelope layer adjoin each other through an intervening oxazoline group-containing substance. The golf ball has improved adhesion between the rubber-based core and the cover layer that directly encases the core and is formed of an ionomer resin or other α,β-ethylenically unsaturated carboxylic acid copolymer-containing resin material.

### CROSS-REFERENCE TO RELATED APPLICATION

This application is a continuation-in-part of copending application Ser. No. 17/120,449 filed on Dec. 14, 2020, claiming priority based on Japanese Patent Application No. 2019-233130 filed in Japan on Dec. 24, 2019, the entire contents of which are hereby incorporated by reference.

### TECHNICAL FIELD

The present invention relates to a golf ball having a core of one or more layer and a cover of one or more layer which encases the core, and to a method of manufacturing such a golf ball. More specifically, the invention relates to a golf ball in which adhesion between the outermost layer of the core and the adjacent cover layer is enhanced, and to a method of manufacture thereof.

### BACKGROUND ART

Solid golf balls with a multilayer structure of three or more pieces have been commonly used in recent years. These multilayer golf balls are generally produced by consecutively injection-molding synthetic resin cover materials around a core so as to form successive layers over the core. However, when adhesion between the layers of the golf ball is poor, this may adversely affect ball properties such as flight, spin on approach shots, feel at impact and durability to cracking. Accordingly, there is a desire for adhesion between these layers to be enhanced.

There already exists numerous art for enhancing adhesion between the layers of a golf ball in order to improve the durability of the ball to impact. In particular, it is common for the core to be formed of a rubber composition and for each cover layer to be formed of a resin material such as an ionomer resin or a thermoplastic elastomer. Because the outermost layer of the core and the adjacent cover layer are formed of differing materials—rubber in the case of the former and a resin in the case of the latter, several technical disclosures have been made in which adhesion between the layers of a golf ball is enhanced by surface-treating the outermost layer of the core. For example, JP-A 2017-099864 describes art which, in order to impart a good interlayer adhesion between adjacent differing layers of a golf ball, carries out surface treatment between the layers with a silane-containing adhesion promoter. JP-A 2013-132312 and JP-A 2014-090957 disclose art in which an aqueous adhesion-promoting treatment is applied to the surface of a golf ball core. JP-A 2013-150690 discloses art which treats the surface of a golf ball core with a urethane resin emulsion, and JP-A 2013-150689 discloses art in which the surface of a golf ball core is treated with rubber latex. Additional art includes JP-A 2003-079766, which subjects the inner cover layer of a golf ball to halogenation, chemical surface treatment or surface treatment with UV irradiation or the like; and JP-A 2003-339912 which, in the production of a golf ball, carries out acid treatment on an intermediate layer made of an ionomeric resin material, thereby enhancing adhesion with an outermost layer made of a polyurethane resin material.

However, when the cover layer adjacent to the rubber core is formed of a resin material containing an α,β-ethylenically unsaturated carboxylic acid copolymer such as an ionomer resin, adhesion between the core and the cover layer is still inadequate, and so there remains room for improvement in the durability to cracking. That is, the prior art lacks a fully effective method for enhancing adhesion between a core composed primarily of rubber and an ionomer resin layer directly encasing the core, and ultimately increasing the durability of the golf ball.

A number of inventions improve golf ball performance attributes such as flight and durability by using oxazoline group-containing substances within layers of the golf ball. For example, JP-A 2001-509204 describes a core-encasing outer layer that is made of an ionomer resin and an oxazoline group-containing copolymer (compatibilizing agent). JP-A H05-068724 includes an oxazoline-modified resin in an ionomer resin serving as a golf ball cover material. JP-A H11-137723 uses an oxazoline-modified rubber as a compatibilizing agent for a crosslinked rubber powder that is included within a resin material. JP-A 2008-264038 teaches the use of an oxazoline compound to suppress declines in physical properties due to the hydrolysis of a polyester resin composed of a non-petroleum-based material. However, in most of this art, an oxazoline group-containing substance is included as an ionomer resin compatibilizing agent within a resin composition, and so this approach is inadequate for improving adhesion between a rubber core and an envelope layer made of a resin material.

### SUMMARY OF THE INVENTION

It is therefore one object of the present invention to provide a golf ball in which adhesion is enhanced between a core composed primarily of rubber and a cover layer which directly encases the core and is formed of a resin material that includes an α,β-ethylenically unsaturated carboxylic acid copolymer such as an ionomer resin, thereby increasing the durability of the ball. A further object of the invention is to provide a method for producing such a golf ball.

As a result of extensive investigations, I have found that by forming the outermost layer in a golf ball core of a rubber composition containing a base rubber and an α,β-unsaturated metal carboxylate, forming an envelope layer directly encasing the core of a resin composition containing a thermoplastic resin having a structure that includes α,β-ethylenically unsaturated carboxylic acid copolymerization units which accounts for at least 50 wt % of the resin composition, and constructing the golf ball such that the surface of the core outermost layer and the envelope layer adjoin each other through an intervening oxazoline group-containing substance, adhesion between the core surface and the envelope layer positioned outside thereof is enhanced.

In addition, I have discovered that by having a method for producing a golf ball which has a core composed of one or more layer include the steps of forming a core outermost layer with a rubber composition containing a base rubber and an α,β-unsaturated metal carboxylate, surface-treating the core outermost layer by bringing a solution that contains an oxazoline group-containing substance into contact with the surface of this layer, and forming an envelope layer by molding, over the surface-treated outermost layer of the core, a resin composition containing a thermoplastic resin having a structure that includes α,β-ethylenically unsaturated carboxylic acid copolymerization units which accounts for at least 50 wt % of the resin composition, adhesion between the core surface and the outwardly adjacent envelope layer can be enhanced without adversely affecting properties of the core surface by what is, in chemical surface treatment of the core surface, a relatively simple method.

Accordingly, in a first aspect, the present invention provides a golf ball having a core composed of one or more layer, wherein an outermost layer of the core is formed of a rubber composition containing a base rubber and an α,β-unsaturated metal carboxylate, an envelope layer which directly encases the core is formed of a resin composition containing a thermoplastic resin having a structure that includes α,β-ethylenically unsaturated carboxylic acid copolymerization units which accounts for at least 50 wt % of the resin composition, and a surface of the core outermost layer and the envelope layer adjoin each other through an intervening oxazoline group-containing substance.

In a preferred embodiment of the golf ball according to the first aspect of the invention, in the envelope layer-forming resin composition, the thermoplastic resin having a structure that includes α,β-ethylenically unsaturated carboxylic acid copolymerization units is an ionomer resin.

In another preferred embodiment of the golf ball of the invention, the neutralization degree of the ionomer resin is less than 80 mol %.

In yet another preferred embodiment of the golf ball of the invention, the oxazoline group-containing substance is an oxazoline group-containing water-soluble polymer.

In still another preferred embodiment of the golf ball of the invention, the rubber composition of the core includes water or an alcohol. It is also preferable that the alcohol used in the embodiment of the golf ball of the invention is a lower alcohol having a molecular weight of less than 200.

In further preferred embodiment of the inventive golf ball, the core has a hardness difference between a center and a surface thereof which is at least 13 on the JIS-C hardness scale.

In more further preferred embodiment of the inventive golf ball, the core has a compression deformation of from 3.8 to 5.5 mm when compressed under a final load of 1,275 N (130 kgf) from an initial load of 98 N (10 kgf).

In a second aspect, the invention provides a method for producing a golf ball having a core composed of one or more layer, which method includes the steps of forming an outermost layer of the core with a rubber composition containing a base rubber and an α,β-unsaturated metal carboxylate; surface-treating the core outermost layer by bringing a solution that contains an oxazoline group-containing substance into contact with a surface of the outermost layer; and forming an envelope layer by molding, over the surface-treated core outermost layer, a resin composition containing a thermoplastic resin having a structure that includes α,β-ethylenically unsaturated carboxylic acid copolymerization units which accounts for at least 50 wt % of the resin composition.

### Advantageous Effects of the Invention

In the golf ball of the invention, adhesion between the rubber-based core and the cover layer which directly encases the core and is formed of a resin material containing an α,β-ethylenically unsaturated carboxylic acid copolymer such as an ionomer resin can be improved. In particular, when a core having a large hardness difference between the core surface and core center is used, the golf ball's durability at impact can be greatly improved. Also, the golf ball production method of the invention carries out a specific surface treatment on the core outermost layer obtained by molding a rubber composition under applied heat, which surface treatment introduces an oxazoline group-containing substance onto the core surface. In this way, golf balls having a sufficiently improved durability can be obtained by a relatively simple method without adversely affecting golf ball properties such as the flight performance and the spin performance.

### DESCRIPTION OF THE PREFERRED EMBODIMENTS

The objects, features and advantages of the invention will become more apparent from the following detailed description.

The golf ball of the invention has a core composed of one or more layer. That is, the core in this invention may be a single-layer core or may be a multilayer core such as two-layer core having an inner layer and an outer layer.

The outermost layer of the core is formed of a rubber composition which includes a base rubber and an α,β-unsaturated metal carboxylate. Preferred examples of this rubber composition include rubber compositions formulated as described below.

The base rubber is not particularly limited, although the use of polybutadiene is especially preferred.

It is desirable for the polybutadiene to have a cis-1,4-bond content on the polymer chain of at least 60 wt %, preferably at least 80%, more preferably at least 90 wt %, and most preferably at least 95 wt %. At a cis-1,4-bond content among the bonds on the polybutadiene molecule that is too low, the rebound may decrease.

The polybutadiene has a content of 1,2-vinyl bonds on the polymer chain which is generally not more than 2 wt %, preferably not more than 1.7 wt %, and more preferably not more than 1.5 wt %. At a 1,2-vinyl bond content which is too high, the rebound may decrease.

The polybutadiene has a Mooney viscosity (ML₁₊₄ (100° C.)) of preferably at least 20, and more preferably at least 30. The upper limit is preferably not more than 120, more preferably not more than 100, and even more preferably not more than 80.

The term “Mooney viscosity” used herein refers to an industrial indicator of viscosity (JIS K 6300) measured with a Mooney viscometer, which is a type of rotary plastometer. This value is represented by the unit symbol ML₁₊₄ (100° C.), wherein “M” stands for Mooney viscosity, “L” stands for large rotor (L-type) and “1+4” stands for a pre-heating time of 1 minute and a rotor rotation time of 4 minutes. The “100° C.” indicates that measurement is carried out at a temperature of 100° C.

The polybutadiene used may be one synthesized with a rare-earth catalyst or a group VIII metal compound catalyst.

A polybutadiene rubber synthesized with a catalyst other than the above rare-earth catalysts may be included in the base rubber. Other rubber ingredients such as styrene-butadiene rubber (SBR), natural rubber, polyisoprene rubber and ethylene-propylene-diene rubber (EPDM) may also be included. These rubber ingredients may be used alone or two or more may be used in combination.

The polybutadiene accounts for a proportion of all the base rubber in the rubber composition which is preferably at least 60 wt %, more preferably at least 70 wt %, and most preferably at least 90 wt %. It is also possible for 100 wt % of the base rubber, i.e., all of the base rubber, to be polybutadiene.

The α,β-unsaturated metal carboxylate is generally used as a co-crosslinking agent. The number of carbon atoms on this unsaturated carboxylic acid is preferably from 3 to 8. Specific examples include unsaturated carboxylic acids such as acrylic acid, methacrylic acid, maleic acid and fumaric acid. Specific examples of the metal in the unsaturated metal carboxylate include zinc, sodium, magnesium, calcium and aluminum, with zinc being especially preferred. The co-crosslinking agent is most preferably zinc acrylate.

The α,β-unsaturated metal carboxylate can be mixed as a metal salt with the base rubber, or may be obtained by chemically reacting, within the base rubber, an α,β-unsaturated carboxylic acid with a metal source such as a metal oxide. In cases where the α,β-unsaturated metal carboxylate is obtained from this chemical reaction, it is preferable to react an amount of the metal constituent sufficient to convert acid groups on the α,β-unsaturated carboxylic acid into a metal salt. When the amount of the metal constituent is insufficient, the hardness of the core obtained may decrease or the rebound may decline.

The content of the α,β-unsaturated metal carboxylate per 100 parts by weight of the base rubber may be set to preferably at least 5 parts by weight, more preferably at least 10 parts by weight, and even more preferably at least 15 parts by weight. The upper limit in the content may be set to preferably not more than 60 parts by weight, more preferably not more than 50 parts by weight, and even more preferably not more than 45 parts by weight. When the content is too high, the ball may become too hard, resulting in an unpleasant feel at impact. When the content is too low, the rebound may decrease.

In addition to the above essential ingredients, the rubber composition may also include a co-crosslinking agent other than the above, an organic peroxide, an inert filler, sulfur, an antioxidant, an organosulfur compound and the like.

Furthermore, the rubber composition may include water or an alcohol.

The water is not particularly limited, and may be distilled water or tap water. The use of distilled water that is free of impurities is especially preferred.

The amount of the water included per 100 parts by weight of the base rubber is preferably at least 0.1 part by weight, and more preferably at least 0.3 part by weight. The upper limit is preferably not more than 5.0 parts by weight, and more preferably not more than 4.0 parts by weight.

The alcohol is not particularly limited, and may be a lower alcohol having a molecular weight of less than 200. As used herein, an “alcohol” refers to a substance having at least one alcoholic hydroxyl group; substances obtained by polycondensing polyhydric alcohols having two or more hydroxyl groups are also included herein as alcohols. A “lower alcohol” refers to an alcohol which has a small number of carbon atoms, and thus a low molecular weight. By including this lower alcohol in the rubber composition, a cured rubber material (core) having the desired core hardness profile can be obtained during vulcanization (curing) of the rubber composition, as a result of which the ball fully achieves a lower spin rate when hit, enabling the ball to be endowed with an excellent flight performance.

It is preferable for the alcohol to be a hexahydric or lower alcohol (an alcohol having up to six alcoholic hydroxyl groups). Specific, examples include, but are not limited to, methanol, ethanol, propanol, butanol, ethylene glycol, diethylene glycol, propylene glycol, dipropylene glycol, tripropylene glycol, glycerol, butanetriol, trimethylolethane, trimethylolpropane, di(trimethylolpropane), pentaerythritol and sorbitol. These have molecular weights which, although not particularly limited, are preferably below 200, more preferably below 150, and even more preferably below 100. When the molecular weight is too large, i.e., when the number of carbons is too high, the desired core hardness profile may not be obtained or a reduced ball spin rate on impact may not be fully achieved.

The content of the alcohol per 100 parts by weight of the base rubber is preferably at least 0.1 part by weight, more preferably at least 0.3 part by weight, and even more preferably at least 0.5 part by weight. The upper limit is preferably not more than 10 parts by weight, more preferably not more than 6 parts by weight, and even more preferably not more than 3 parts by weight. At an alcohol content that is too high, the hardness decreases and the desired feel at impact, durability and rebound may not be obtained. At a content that is too low, the desired core hardness profile may not be obtained and a reduced spin rate may not be fully achieved when the ball is hit.

In cases where the core is composed of a single layer, the single-layer core can be produced from the above-described rubber composition. In cases where the core is composed of a plurality of layers, the material making up the center core may be a rubber material of the same type as that in the outermost layer described above, or the center core may instead be made of a rubber composition in which the types and contents of the compounding ingredients differ from the above or may be made of a known resin material.

A vulcanizate (core) can be produced by vulcanizing/curing the above rubber composition. This vulcanizate may be used as part or all of the single-layer or multilayer core. For example, the core which is a vulcanizate can be produced by using a mixing apparatus such as a Banbury mixer or a roll mill to knead the rubber composition, compression-molding or injection-molding the kneaded composition using a core mold, and suitably heating the molded body at a temperature sufficient for the organic peroxide and co-crosslinking agent to act, such as between about 100° C. and 200° C., for 10 to 40 minutes so as to cure the molded body.

In order to be able to increase the durability of the golf ball while maintaining good spin properties, it is preferable for the core to have a hardness profile in which the hardness difference between the surface and the center is large.

The core center hardness on the JIS-C hardness scale, although not particularly limited, is preferably at least 30, more preferably at least 40, and even more preferably at least 50. The upper limit is preferably not more than 80, more preferably not more than 70, and even more preferably not more than 60. At a core center hardness outside of this range, the feel at impact may worsen or the durability may decrease, and a spin rate-lowering effect may not be obtainable.

The core surface hardness on the JIS-C hardness scale, although not particularly limited, is preferably at least 50, more preferably at least 60, and even more preferably at least 70. The upper limit is preferably not more than 98, more preferably not more than 96, and even more preferably not more than 94. At a core surface hardness that is lower than this range, the ball rebound may decrease and a sufficient distance may not be obtained. On the other hand, at a core surface hardness that is higher than this range, the feel at impact may become too hard or the durability to cracking under repeated impact may worsen.

With regard to the core hardness profile, from the standpoint of the ball spin performance, it is preferable for the hardness difference between the core surface and the core center to be large. Specifically, the hardness difference between the core surface and core center, expressed on the JIS-C hardness scale, is preferably at least 13, more preferably at least 20, and even more preferably at least 25. The upper limit is preferably not more than 60, more preferably not more than 50, and even more preferably not more than 40. When the hardness difference is too small, the spin rate-lowering effect on shots with a driver (W #1) may be inadequate and a good distance may not be obtained. On the other hand, when the hardness difference is too large, the initial velocity of the ball on actual shots may decrease and a good distance may not be obtained, or the durability to cracking on repeated impact may worsen. As used herein, “center hardness” refers to the hardness measured at the center of the cross-section obtained by cutting the core in half through the center, and “surface hardness” refers to the hardness measured at the spherical surface of the core. Also, “JIS-C hardness” refers to the hardness measured with the spring-type durometer (JIS-C model) specified in JIS K 6301-1975.

The core diameter is not particularly limited and depends also on the layer structure of the golf ball to be produced, but is preferably at least 30 mm, and more preferably at least 35. The upper limit is preferably not more than 41 mm, and more preferably not more than 40 mm. When the core diameter falls outside of this range, the initial velocity of the ball may decrease or a suitable spin performance may not be obtained.

It is preferable for the core to have a compressive deformation when compressed under a final load of 1,275 N (130 kgf) from an initial load of 98 N (10 kgf) which is at least 3.8 mm. This compressive deformation is more preferably at least 4.0 mm. Although there is no particular upper limit, the compressive deformation of the core is preferably not more than 5.5 mm, and more preferably not more than 5.0 mm. When this value is too small, the feel of the ball on impact may worsen, and on long shots such as with a driver that cause a large ball deformation, the spin rate may rise excessively, resulting in a poor distance. When this value is too large, the core becomes too soft, as a result of which the feel of the ball on impact may worsen, the resilience may decrease, and the durability to cracking on repeated impact may worsen.

It is preferable to carry out surface treatment of the outermost layer of the core by bringing an acid-containing solution into contact with the surface of the core outermost layer. Generally, following hot molding of the core-forming rubber composition, unsaturated carboxylic acid is neutralized with metal ions owing to the inclusion of a co-crosslinking agent such as zinc acrylate, and so the level of free unsaturated carboxylic acid is not high. It is thought that by bringing an acid-containing solution into contact with the surface of the core outermost layer, a sufficient amount of demetallized carboxyl groups form only at the surface portion and new chemical bonds mediated by an oxazoline group-containing substance form with acid groups in the adjoining envelope layer, so that adhesion improves compared with an untreated core surface.

The acid used in acid treatment is not particularly limited, so long as it is an acid which can remove metal ions from an ionomer resin and protonize a carboxylic acid. Illustrative examples include hydrochloric acid, sulfuric acid and nitric acid. In particular, from the standpoint of the ease of carrying out the operation, the use of hydrochloric acid is preferred. The acid concentration when used, although not particularly limited, is preferably at least 0.05 mol/L, and more preferably at least 0.1 mol/L. The upper limit is preferably not more than 10 mol/L, more preferably not more than 5 mol/L, even more preferably not more than 3 mol/L, and most preferably not more than 1 mol/L. When the acid concentration is too low, an adhesion-improving effect between the core surface and the envelope layer may not be observed. When the acid concentration is too high, this may adversely affect the ball properties rather than enhancing the core surface properties.

For the acid to better penetrate to the interior of the rubber or resin serving as the core material and for increased affinity, it is preferable for the acid-containing solution to include also an alcohol. As a result, demetallization treatment of the metal salt at the core surface due to acid treatment can be made to proceed rapidly. The alcohol used is preferably a lower alcohol having up to four carbon atoms, such as ethanol or 2-propanol.

The acid treatment method used is preferably one that involves subjecting surface regions of the core outermost layer to dipping, painting (spraying), infiltration under applied heat and pressure, dropwise application or the like. The use of a dipping method is especially preferred. For example, when the core is dipped in an acid-containing solution, dipping may be carried out for a period of from 1 to 60 minutes, especially 1 to 10 minutes.

The acid treatment temperature may be set to between 10° C. and 30° C., and especially between 20° C. and 25° C.; room temperature or atmospheric temperature generally suffices. Following acid treatment (acid washing), washing may be carried out in which the core is thoroughly rinsed with water so that acid does not remain on the surface. The water rinsing method is not particularly limited. For example, use can be made of a method such as washing with a large amount of water.

Prior to the above acid treatment, it is preferable to abrade the surface of the core outermost layer. The method of abrasion is exemplified by a process that involves randomly rotating the core in a diamond grinding wheel, a process that uses diamond paper, and a sand blasting process.

Additionally, in the practice of this invention, to construct the golf ball such that the surface of the core outermost layer and the envelope layer adjoin each other through an intervening oxazoline group-containing substance, it is preferable to surface-treat the core outermost layer by bringing a solution containing an oxazoline group-containing substance into contact with the surface of the outermost layer. Owing to this oxazoline group-containing substance, carboxylic acid groups from which metal ions have been removed in the core outermost layer chemically bond with the oxazoline groups, and the oxazoline groups chemically bond with unneutralized carboxyl groups remaining in the ionomer resin or the like present within the subsequently described envelope layer, enabling the core and the envelope layer to firmly adhere through the oxazoline group-containing substance.

No particular limitation is imposed on the oxazoline group-containing substance, so long as it is a chemical substance having oxazoline groups. However, from the standpoint of, for example, the means used to impregnate the oxazoline group-containing substance into the core surface, the use of an oxazoline group-containing water-soluble polymer is preferred. Examples include oxazoline group-containing acrylic polymers and oxazoline group-containing styrene polymers.

To achieve both a good effect between the core surface and the envelope and also a good ball durability, the oxazoline group content per gram of polymer in the acrylic polymer or styrene polymer is preferably from 0.1×10⁻³ to 10×10⁻³ mol/g (solids), and especially from 0.2×10⁻³ to 8×10⁻³ mol/g (solids).

A commercial product may be used as the oxazoline group-containing polymer. Illustrative examples include the acrylic polymers Epocros® WS-500, Epocros® WS-300 and Epocros® WS-700 and the styrene polymer Epocros® RPS-100, all from Nippon Shokubai Co., Ltd.

From the standpoint of uniformly treating the surface of the core outermost layer, the solution containing the oxazoline group-containing substance is preferably an alcoholic solution. Preferred examples of the alcohol used in the alcoholic solution include methanol, ethanol, propanol and 1-methoxy-2-propanol.

Following surface treatment at the surface of the core outermost layer with the above solution containing an oxazoline group-containing substance, a step in which drying is carried out at a given temperature and for a given time may be provided. The reason for doing so is to induce partial reaction of the demetallized carboxyl groups in the outermost layer surface with oxazoline groups and thereby further strengthen adhesion with the subsequently described envelope layer. Treatment may be carried out at a treatment temperature of generally 80° C. or less, preferably 60° C. or less, and more preferably 50° C. or less. Even treatment at room temperature is acceptable. The treatment time is preferably a time sufficient for about half of the oxazoline groups to react. For example, as a general rule, at a treatment temperature of 60° C., the treatment time may be set to about 4 hours. If the treatment temperature is too high or the treatment time is too long, all of the oxazoline groups may end up reacting and subsequent reaction with acid groups within the envelope layer may not adequately take place, as a result of which the adhesion may diminish.

The golf ball of the invention has an envelope layer which directly encases the core. This envelope layer makes up part or all of the cover. That is, in cases where the cover consists of a single layer, this envelope layer (cover layer) serves as the outermost layer in the layer structure of the golf ball. In cases where the cover is composed of a plurality of layers, one or more additional cover layer is formed on the outside of this envelope layer.

The envelope layer is formed of a resin composition having a thermoplastic resin with a structure that includes α,β-ethylenically unsaturated carboxylic acid copolymerization units.

In the thermoplastic resin having a structure that includes α,β-ethylenically unsaturated carboxylic acid copolymerization units, the thermoplastic resin accounts for a proportion of the resin composition for the envelope layer which is preferably at least 50 wt %, more preferably at least 60 wt %, and most preferably at least 80 wt %. At too low proportion of the above thermoplastic resin, a sufficient adhesion between a core and an envelope layer may not be obtained.

The thermoplastic resin having a structure that includes α,β-ethylenically unsaturated carboxylic acid copolymerization units is not particularly limited, although it is preferably one which includes either (a) an ethylene-α,β-unsaturated carboxylic acid copolymer and/or a metal salt thereof or (b) an ethylene-α,β-unsaturated carboxylic acid-α,β-unsaturated carboxylic acid ester copolymer and/or a metal salt thereof.

The amount of unsaturated carboxylic acid included in the above thermoplastic resin (acid content) is generally at least 7 wt %, preferably at least 10 wt %, and more preferably at least 12 wt %. The upper limit is preferably not more than 30 wt %, more preferably not more than 25 wt %, and even more preferably not more than 20 wt %.

Specific examples of the α,β-unsaturated carboxylic acid in components (a) and (b) include acrylic acid, methacrylic acid, maleic acid and fumaric acid. Acrylic acid and methacrylic acid are especially preferred. The α,β-unsaturated carboxylic acid ester in component (b) is preferably a lower alkyl ester of the above unsaturated carboxylic acid, specific examples of which include methyl methacrylate, ethyl methacrylate, propyl methacrylate, butyl methacrylate, methyl acrylate, ethyl acrylate, propyl acrylate and butyl acrylate. Butyl acrylate (butyl n-acrylate, butyl i-acrylate) is especially preferred.

Metal ion neutralization products of the copolymers in components (a) and (b) can be obtained by partially neutralizing acid groups in the olefin-unsaturated carboxylic acid copolymer or the olefin-unsaturated carboxylic acid-unsaturated carboxylic acid ester copolymer with metal ions. Illustrative examples of metal ions which neutralize the acid groups include Na⁺, K⁺, Li⁺, Zn⁺⁺, Cu⁺⁺, Mg⁺⁺, Ca⁺⁺, Co⁺⁺, Ni⁺⁺ and Pb⁺⁺. Preferred use can be made of Na⁺, Zn⁺, Mg⁺⁺ and Ca⁺⁺ in particular. Such neutralization products may be obtained by a known method. For example, a neutralization product may be obtained by using, for reaction with the above copolymer, a compound such as a formate, acetate, nitrate, carbonate, bicarbonate, oxide, hydroxide or alkoxide of the above metal ion.

Known substances may be used as components (a) and (b). Illustrative examples include commercial products such as the following acid copolymers: Nucrel® N1560, Nucrel® N1214, Nucrel® N1035, Nucrel® AN4221C, Nucrel® AN4311, Nucrel® AN4318 and Nucrel® AN4319 (all products of Dow-Mitsui Polychemicals Co., Ltd.). Illustrative examples of metal ion neutralization products of acid copolymers include Himilan® 1554, Himilan® 1557, Himilan® 1601, Himilan® 1605, Himilan® 1706, Himilan® AM7311, Himilan® 1855, Himilan® 1856 and Himilan® AM7316 (all products of Dow-Mitsui Polychemicals Co., Ltd.), and Surlyn® 7930, Surlyn® 6320, Surlyn® 8320, Surlyn® 9320, Surlyn® 8120, Surlyn® 8460, Surlyn® 9910 and Surlyn® 9650 (The Dow Chemical Company).

The degree of neutralization of acid groups in the above neutralization products is preferably not more than 80 mol %, and more preferably not more than 60 mol %. When this degree of neutralization is too high, the ionomer and the oxazoline group-containing polymer have difficulty forming a crosslinked structure and the compatibility of both polymers worsen, which is undesirable.

The resin composition in the envelope layer may also suitably include known resins other than the above thermoplastic resin having a structure that includes α,β-ethylenically unsaturated carboxylic acid copolymerization units, and various types of additives.

In cases where the cover has a plurality of layers, one or more other cover layer may additionally be formed outside of this envelope layer. A known thermoplastic resin or thermoplastic elastomer, such as an ionomer or a thermoplastic polyurethane elastomer, may be used as the chief material in this cover layer.

The method used to obtain the cover layers (envelope layer, and cover layers other than the envelope layer) in this invention may be, for example, a method in which, depending on the type of ball being produced, a pre-fabricated single-layer core or multilayer core of two or more layers is placed in a mold and the above mixture is mixed and melted under heating and then injection-molded over the core, thereby encasing the core with the desired cover layer or layers. Another method that may be used to form the cover layers involves molding the cover material into a pair of hemispherical half-cups, enclosing the core with these half-cups, and then molding under applied pressure at between 120° C. and 170° C. for 1 to 5 minutes.

When the cover is a one-layer cover, that is, when the cover is composed of only an envelope layer, the thickness of that layer may be set to from 0.3 to 3 mm. When the cover is composed of two layers, the cover layer outside of the envelope layer (i.e., the outermost layer) may be set to a thickness of from 0.3 to 2.0 mm and the envelope layer (inner cover layer) may be set to a thickness of from 0.3 to 2.0 mm. The cover layers making up the cover each have a Shore D hardness which, although not particularly limited, is preferably at least 40, and more preferably at least 45, but is preferably not more than 70, and more preferably not more than 65.

Numerous dimples may be formed on the surface of the outermost layer of the cover. Also, various types of treatment, such as surface preparation, stamping and painting, may be carried out on the surface of the cover outermost layer.

### EXAMPLES

The following Examples of the invention and Comparative Examples are provided to illustrate the invention, and are not intended to limit the scope thereof.

### Examples 1 to 4, Comparative Examples 1 to 4

Using the three types of core materials (X, Y, Z) composed primarily of polybutadiene shown in Table 1 below, core compositions having the rubber formulations shown in Table 1 are prepared. The core compositions are subjected to 20 minutes of vulcanization at 155° C., and the core surface is abraded, thereby producing 38.6 mm-diameter cores.

TABLE 1

| Type of core | | X | Y | Z |
|---|---|---|---|---|
| Core | Polybutadiene | 100 | 100 | 100 |
| formulation | Zinc acrylate | 40 | 26 | 25 |
| (pbw) | Organic peroxide | 1 | 1 | 1 |
| | Zinc oxide | 15.4 | 21.1 | 21.4 |
| | Propylene glycol | | 1 | |
| | Water | 1 | | |
| | Antioxidant (1) | 0.2 | | 0.2 |
| | Antioxidant (2) | | 0.3 | |
| Core | Diameter (mm) | 38.6 | 38.6 | 38.6 |
| properties | Weight (g) | 35.0 | 35.0 | 35.0 |
| | Compressive hardness (mm) | 4.03 | 4.01 | 4.05 |
| | Surface hardness A (JIS-C) | 76.8 | 80.4 | 70.5 |
| | Center hardness B (JIS-C) | 53.1 | 54.2 | 56.6 |
| | Hardness difference A-B | 23.7 | 26.2 | 13.9 |
| | (JIS-C) | | | |

Details on the above formulations are given below.
Polybutadiene: Available under the trade name “BR 01” from JSR Corporation
Zinc acrylate: Available under the trade name “ZN-DA85S” (85% zinc acrylate/15% zinc stearate) from Nippon Shokubai Co., Ltd.
Organic peroxide (dicumyl peroxide): Available under the trade name “Percumyl D” from NOF Corporation
Zinc oxide: Available as “Zinc Oxide Grade 3” from Sakai Chemical Co., Ltd.
Propylene glycol (a dihydric alcohol): molecular weight, 76.1 (from Hayashi Pure Chemical Ind., Inc.)
Water: Distilled water
Antioxidant (1): Available under the trade name “Nocrac NS-6” from Ouchi Shinko Chemical Industry Co., Ltd.
Antioxidant (2): Available under the trade name “Nocrac MB” from Ouchi Shinko Chemical Industry Co., Ltd.

### Center and Surface Hardnesses of Core

The surface and center hardnesses of the three above types of 38.6 mm-diameter cores are measured by the following methods.

At a temperature of 23±1° C., the hardnesses at four random points on the core surface are measured with a JIS-C durometer by perpendicularly setting the durometer indenter against the spherical surface of the core. The average value of these measurements is treated as the measured value for one core, and the average value for three measured cores is determined. Also, the core is cut through the center to obtain a flat cross-section. At a temperature of 23±1° C., the center hardness of the hemispherical core is measured with a JIS-C durometer by perpendicularly setting the durometer indenter against the flat cross-section, thereby obtaining the measurement for one core. The average value for three measured cores is determined. These measurements are presented in Table 1.

### Compressive Hardnesses of Core

The compressive hardness (deformation) (mm) of each core when compressed at a rate of 10 mm/s under a final load of 1,275 N (130 kgf) from an initial load state of 98 N (10 kgf) is measured at a temperature of 23±1° C. The average value for ten measured cores is determined.

### Surface Treatment of Core

The following four types of surface treatment are carried out on the three above types of cores.
Core surface treatment (I): After being abraded, the core is washed with water and then dried at room temperature (20 to 25° C.).
Core surface treatment (II): After being abraded, the core is washed with an ethanol solution and then dried at room temperature (20 to 25° C.).
Core surface treatment (III): After being abraded, the core is dipped for 1 minute at a liquid temperature of 23° C. in an Epocros® solution (mixed solution of Epocros® WS-500: ethanol=1:20 (weight ratio)) and then dried at room temperature (20 to 25° C.).
Core surface treatment (IV): After being abraded, the core is dipped for 1 minute at 23° C. in a 0.1 mol/L hydrochloric acid 2-propanolic treatment solution, following which the dipped core is washed with an ethanol solution and then dried at room temperature (20 to 25° C.). The core is subsequently dipped for 1 minute at a liquid temperature of 23° C. in an Epocros® solution (mixed solution of Epocros® WS-500: ethanol=1:20 (weight ratio)) and then dried at room temperature (20 to 25° C.).

Epocros® WS-500 is an acrylic polymer from Nippon Shokubai Co., Ltd. which is a light-yellow liquid (water-soluble) and has an oxazoline group content of 4.5 mmol/g (solids), a glass transition temperature of 50° C., a number-average molecular weight (Mn) of 20,000 and a weight-average molecular weight (Mw) of 70,000.

### Formation of Envelope Layer and Outermost Layer

Next, using an injection mold, the envelope layer material (ionomer resin material) shown in Table 2 is injection-molded over the core surface, thereby forming an envelope layer having a thickness of 1.25 mm and a Shore D hardness of 64. Using a different injection mold, the outermost layer material (urethane resin material) shown in Table 2 is then injection-molded over the envelope layer-encased sphere, thereby forming an outermost layer having a thickness of 0.8 mm and a Shore D hardness of 41.

TABLE 2

| Compounding ingredients (pbw) | | | | |
|---|---|---|---|---|
| | | Neutralization | | |
| | Acid content | degree | Envelope | Outermost |
| | (wt %) | (mol %) | layer | layer |
| Surlyn 9910 | 15 | 59 | 35 | |
| Surlyn 9650 | 11 | 58 | 15 | |
| Surlyn 8460 | 15 | 29 | 50 | |

| | | |
|---|---|---|
| TPU | | 100 |
| Polyethylene wax | | 1.0 |
| Isocyanate compound | | 6.3 |
| Titanium oxide | | 3.3 |
| Trimethylolpropane | 1.1 | |

Details on the compounding ingredients in this table are given below.
Surlyn 9910, Surlyn 9650: Ethylene methacrylic acid copolymer, partially neutralized with zinc ions available from The Dow Chemical Company
Surlyn 8640: Ethylene methacrylic acid copolymer, partially neutralized with sodium ions available from The Dow Chemical Company
TPU: An ether-type thermoplastic polyurethane available under the trade name “Pandex” from DIC Covestro Polymer, Ltd.; Shore D hardness, 41
Polyethylene wax: Available under the trade name “Sanwax 161P” from Sanyo Chemical Industries, Ltd.
Isocyanate compound: 4,4′-Diphenylmethane diisocyanate

The compressive hardness and durability to cracking of the resulting golf balls are evaluated by the following methods. The results are presented in Table 3. The compressive hardness and durability to cracking for all of the balls are measured after letting the manufactured balls stand for one month at 23° C. following completion.

### Compressive Hardness of Ball

The compressive hardness (deformation) (mm) of the golf ball in each Example when compressed at a speed of 10 mm/s under a final load of 1,275 N (130 kgf) from an initial load state of 98 N (10 kgf) is measured at a temperature of 23±1° C. In each case, the average value for ten measured balls is determined.

### Durability to Cracking

The durability of the golf ball is evaluated using an ADC Ball COR Durability Tester produced by Automated Design Corporation (U.S.). This tester fires a golf ball pneumatically and causes it to consecutively strike two metal plates arranged in parallel. The incident velocity against the metal plates is set to 43 m/s. The number of shots required for the golf ball to crack is measured, and the average value of the measurements taken for ten golf balls is calculated. Durability indices for the balls in the respective Examples are calculated relative to an arbitrary index of 100 for the average number of shots required for the ball obtained in Comparative Example 4 to crack and are shown in Table 3. The durability index difference between the ball in an Example of the invention and the ball in a Comparative Example having the same type of core is indicated in Table 3 as the “Degree of improvement.”

TABLE 3

| | | | Example | | | | Comparative Example | | | |
|---|---|---|---|---|---|---|---|---|---|---|
| | | | 1 | 2 | 3 | 4 | 1 | 2 | 3 | 4 |
| Core | Type | | X | Y | Z | Z | X | Y | Z | X |
| (before | Compressive hardness (mm) | | 4.03 | 4.01 | 4.05 | 4.05 | 4.03 | 4.01 | 4.05 | 4.03 |
| surface | JIS-C hardness difference | | 23.7 | 26.2 | 13.9 | 13.9 | 23.7 | 26.2 | 13.9 | 23.7 |
| treatment) | (surface - center) | | | | | | | | | |
| Core surface treatment | | | (IV) | (IV) | (IV) | (III) | (I) | (I) | (I) | (II) |
| Ball | Compressive hardness (mm) | | 3.26 | 3.24 | 3.30 | 3.30 | 3.26 | 3.24 | 3.30 | 3.26 |
| | Durability | Index | 125 | 128 | 130 | 112 | 100 | 103 | 109 | 100 |
| | to cracking | Degree of improvement* | +25 | +25 | +21 | +3 | — | — | — | 0 |

*“Degree of improvement” refers to the durability index difference relative to Treatment I (non-treatment of core surface) in balls having the same type of core.

Japanese Patent Application No. 2019-233130 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core composed of one or more layer, wherein an outermost layer of the core is formed of a rubber composition containing a base rubber and an α,β-unsaturated metal carboxylate, an envelope layer which directly encases the core is formed of a resin composition containing a thermoplastic resin having a structure that includes α,β-ethylenically unsaturated carboxylic acid copolymerization units which accounts for at least 50 wt % of the resin composition, and a surface of the core outermost layer and the envelope layer adjoin each other through an intervening oxazoline group-containing substance.

2. The golf ball of claim 1 wherein, in the envelope layer-forming resin composition, the thermoplastic resin having a structure that includes α,β-ethylenically unsaturated carboxylic acid copolymerization units is an ionomer resin.

3. The golf ball of claim 2, wherein the neutralization degree of the ionomer resin is less than 80 mol %.

4. The golf ball of claim 1, wherein the oxazoline group-containing substance is an oxazoline group-containing water-soluble polymer.

5. The golf ball of claim 1, wherein the rubber composition of the core includes water or an alcohol.

6. The golf ball of claim 1, wherein the rubber composition of the core includes a lower alcohol having a molecular weight of less than 200.

7. The golf ball of claim 1, wherein the core has a hardness difference between a center and a surface thereof which is at least 13 on the JIS-C hardness scale.

8. The golf ball of claim 1, wherein the core has a compression deformation of from 3.8 to 5.5 mm when compressed under a final load of 1,275 N (130 kgf) from an initial load of 98 N (10 kgf).

9. A method for producing a golf ball having a core composed of one or more layer, which method comprises the steps of:
forming an outermost layer of the core with a rubber composition containing a base rubber and an α,β-unsaturated metal carboxylate;
surface-treating the core outermost layer by bringing a solution that contains an oxazoline group-containing substance into contact with a surface of the outermost layer; and
forming an envelope layer by molding, over the surface-treated core outermost layer, a resin composition containing a thermoplastic resin having a structure that includes α,β-ethylenically unsaturated carboxylic acid copolymerization units which accounts for at least 50 wt % of the resin composition.

10. The method of claim 9 which further comprises, prior to surface-treating the core outermost layer with a solution that contains an oxazoline group-containing substance, the step of surface-treating the outermost layer of the core by bringing an acid-containing solution into contact with the surface of the outermost layer.

11. The method of claim 9, wherein the thermoplastic resin having a structure that includes α,β-ethylenically unsaturated carboxylic acid copolymerization units includes an ionomer resin, and the neutralization degree of the ionomer resin is less than 80 mol %.

12. The method of claim 9, wherein the rubber composition of the core includes water or an alcohol.

13. The method of claim 9, wherein the rubber composition of the core includes a lower alcohol having a molecular weight of less than 200.

14. The method of claim 9, wherein the core has a hardness difference between a center and a surface thereof which is at least 13 on the JIS-C hardness scale.

15. The method of claim 9, wherein the core has a compression deformation of from 3.8 to 5.5 mm when compressed under a final load of 1,275 N (130 kgf) from an initial load of 98 N (10 kgf).
